(19) United States
(12) Patent Application Publication
(10) Pub. No.: US 2007/0227834 A1
(43) Pub. Date: Oct. 4, 2007

(54) Braking Device

(76) Inventors: Jan Mieze, Hamburg (DE); Matthias Porschatis, Hamburg (DE); Amin Segeler, Grunendeich (DE); Michael Siemers, Buchholz (DE); Rene Tibke, Buxtehude (DE); Yongxing Wang, Wulmstorf (DE); Kai Sascha Zimmermann, Drage (DE)

Correspondence Address: AKERMAN SENTERFITT, P.O. BOX 3188, WEST PALM BEACH, FL, 33402-3188, US

(21) Appl. No.: 10/567,800

(22) PCT Filed: Aug. 4, 2004
(86) PCT No.: PCT/EP04/08722

§ 371 Date: Mar. 19, 2007

(30) Foreign Application Priority Data
Aug. 9, 2003 (DE) 103 36 667.9

(51) Int. Cl. B60T 11/04

(52) U.S. Cl. 188/2 R

(57) ABSTRACT

In the braking device according to the invention for a vehicle for actuating at least one braking module, a secondary transmission which is embodied as a block and tackle is provided to transmit a force between a primary transmission and the at least one braking module. In this case, the block and tackle has a tension element (5) and at least one roller (2, 3). The at least one braking module interacts with an assigned roller (2, 3). In this case, it is provided that the tension element (5) is anchored at one end (53) and is guided at least over the one assigned roller (2, 3) and at least one additional roller (3, 2) and is connected at the other end (52) to a loading device (7). In the braking device, loading the tension element (5) changes the state of the at least one braking module by moving the assigned roller (2, 3).

### CROSS REFERENCE TO RELATED APPLICATION

This application is a national stage of PCT/EP2004/008722 filed Aug. 4, 2004 and based upon DE 103 36 667.9 filed Aug. 9, 2003 under the International Convention.

### BACKGROUND OF THE INVENTION

### Field of the Invention

The invention relates to a braking device for a vehicle for actuating at least one braking module and also to a force transmission device for a vehicle for actuating at least one braking module.

### SUMMARY OF THE INVENTION

Vehicle brakes are generally embodied in such a way that forces are transmitted, by means of suitable devices, to wheels or axles of the vehicle when a corresponding lever or a brake pedal is actuated. This has the effect that a speed of the vehicle is reduced or, such as in the case of a parking brake, a position of the vehicle is fixed.

To transmit such forces, use can be made in braking devices of a very wide range of physical mechanical and/or electromagnetic principles effected by means of a very wide range of devices. In the selection of these devices, requirements made of the respective braking device as well as given boundary conditions must be taken into account.

If it is for example required that two wheel brakes—each for a respective wheel—be loaded with force in equal measure, so that the wheels are braked or fixed simultaneously and/or in equal measure, then a braking device which is suitable for this purpose should transmit the forces to the wheels in equal measure.

For this purpose, it is for example proposed in the document DE-Patent 355 153, that the position of a roller, along which a tension cable is tensioned which is connected at one end to one wheel brake and at another end to another wheel brake, is varied so that the wheel brakes are loaded simultaneously by the tension cable.

A braking force distributor gearing disclosed in the document DE 197 33 552 C2 functions in a similar manner. Two wheel brakes are also connected to one another here by means of a cable which is guided over a roller. Furthermore, this document describes a mechanism for changing the position of the roller by means of a cable pull which is connected to an actuating element.

An equalizing device for a cable pull braking system which is described in the document DE 199 53 947 A1 functions in a contrasting manner. Here, two brake pulls—each for a respective brake—are jointly connected to an axle of a roller. An actuating pull which is guided over the roller is fixed at one end and connected to an actuating lever at another end. Pulling the actuating pull changes the position of the roller, as a result of which the brake pulls are in turn loaded.

In addition, correspondingly embodied braking devices can fulfill and/or improve further functions.

Against this background, a braking device is proposed and a force transmission device is also proposed.

The braking device according to the invention for a vehicle is designed to actuate at least one braking module and has a secondary transmission which is embodied as a block and tackle and transmits a force between a primary transmission and the at least one braking module. As a result, a braking device is provided which can be produced cost-effectively and functions in a mechanically simple manner yet is effective and can be embodied in a variety of ways.

The secondary transmission is embodied as a block and tackle having at least one roller and a tension element which interact. In most cases of known comparable devices, transmissions are designed to have a secondary transmission in the form of a spindle. It is in this case disadvantageous that spindles have poor efficiency. The braking device according to the invention is improved in comparison to this, particularly as a block and tackle is quiet and also has good efficency.

In one possible embodiment of the invention, it can be provided that the primary transmission be embodied as a worm gear. Primary transmissions are generally embodied as spur gear transmissions, but these have the disadvantage of being very noisy in comparison with worm gears.

Furthermore, it can be provided that the braking device according to the invention be embodied as an electric motor having the primary transmission and the secondary transmission. As a result, braking commands from a person in control of the vehicle can be transmitted more effectively than they would be with purely mechanically or hydraulically functioning devices.

On account of the positive efficiency and the optimum acoustic properties, a quiet electric brake, preferably a parking brake, which requires little installation space can be provided.

In a particularly advantageous embodiment, it is provided that the braking module interacts with an assigned roller. In this case, it is provided that a tension element is anchored at one end, is guided at least over the one assigned roller and at least one additional roller, and is connected at another end to a loading device.

In the braking device, loading the tension element changes the state of the at least one braking module by moving the assigned roller. The braking device according to the invention accordingly has a force transmission device which is constructed like a block and tackle with a tension element and at least one roller. The advantages that can be obtained with a block and tackle, such as redirection or distribution of forces as well as an increase in forces, are shown to advantage in the braking device according to the invention. An initial force with which the tension element is loaded can, according to the invention, be amplified so that the at least one braking module is loaded by a higher effective end force.

In an advantageous embodiment of the invention, the braking device is designed to actuate at least two braking modules which each interact with an assigned roller, a tension element being anchored at one end and being guided at least over the at least two assigned rollers and being connected at the other end to a loading device. In this case, loading the tension element changes the state of the at least two braking modules by moving the respective assigned roller. This embodiment allows two or more braking modules to be loaded simultaneously and/or in equal measure and/or with substantially identical forces. The prevailing forces can be effectively distributed and/or amplified or utilized.

An enormous variety of concepts for realizing the invention are possible on account of the simple possibility of realization with simple mechanical devices, the tension element and the at least one roller. With a corresponding embodiment having any suitably selectable number of rollers, a correspondingly large number of braking modules can be loaded. The possibility of a variety of arrangements of the rollers relative to one another and of guiding of the tension element over or along the rollers allows the braking device to be adapted to different requirements or boundary conditions.

According to the invention, it is provided that each roller changes a direction of the tension element which is tensioned between a loading device and an anchor. In this case, it can for example be provided that the tension element is deflected by 180°, or by a suitable angle interval around 180°, by a respective roller. In this case, larger or smaller angles which are expedient according to the invention can of course be selected. As a result, with the invention, braking modules at various positions in the vehicle can be advantageously loaded. The braking device can preferably be used flexibly for specific applications in different vehicles. Any number of braking modules which interact with a corresponding number of rollers can be loaded with the braking device.

According to the invention, it is provided that; on account of loading, the tension element causes a change in position of the at least one assigned roller. As a result, it is possible for the braking module which interacts with the assigned roller to be loaded by this change in position.

In this case, according to the invention, it is provided that the at least one braking module is connected to the respective assigned roller. This embodiment of the invention allows the movement of the assigned roller, which results from loading the tension element, to be transmitted to the at least one braking module. As a result, a reciprocal action is possible between the at least one braking module and the respective assigned roller.

In an advantageous embodiment of the invention, it is provided that a tension device is arranged between the at least one braking module and the respective assigned roller. With this tension device, forces can be transmitted between the at least one braking module and the respective assigned roller. Depending on the embodiment of the braking module, the entire braking module can, as determined by the tension device, be moved relative to a device to be braked, such as a wheel and/or an axle of a vehicle, in order to load the wheel and/or the axle. For this purpose, it is of course also possible to move only a component part of the braking module by means of the tension device.

In one embodiment of the invention, it is provided that a stress between the at least one braking module and the respective assigned roller can be changed. For this purpose, it can be provided that a change in the position of a rotational axle of the roller according to a translational movement of the roller within the braking device and/or relative to the braking module is decisive. The assigned roller pulls the braking module to a corresponding extent by means of the tension device. Rotation of the roller about the rotational axle as a result of loading by means of the tension element serves, according to the invention, to manipulate the prevailing forces according to the block and tackle principle.

The braking device according to the invention can also be embodied in such a way that different braking modules are therefore loaded at the same time with different forces. In order to obtain this, the rollers must be correspondingly arranged and tension elements must be correspondingly guided.

In a further embodiment of the invention, it is provided that the at least one assigned roller is arranged on a holding device in a moveable manner. The holding device provides a basis for the assigned roller to perform a translational movement relative to the at least one respective braking module. For this purpose, the roller can be fastened to a guide device which is suitable for this and on which said roller, in the event of a respective change in position according to loading by the tension element and whilst transmitting forces which occur in this case on to the braking module, can be moved by means of the tension device.

The braking device and therefore the at least one braking module can, by means of the loading device, be controlled by a person in control of the vehicle. The person can, by means of a suitable actuating element such as a brake lever or a brake pedal, transmit a brake and/or stop command, in the case of a parking brake, to the loading device and therefore to the braking device and, as a result, to the at least one braking module. The braking device according to the invention can be set in such a way that equilibrium prevails between both the tension element which is loaded by the loading device and all of the braking modules, as determined by a instantaneous setting (movement and/or fixed position) of the assigned rollers relative to the holding device or the respective guide devices.

A state of the tension element results in turn according to how the tension element is tensioned or positioned between the anchor and the loading device, dependent on an adjustable state of the loading device. This is dependent on how all of the moveable rollers of the braking device according to the invention are loaded, and as a result positioned dynamically and/or statically, in such a state of equilibrium.

In this case, it can be provided that the tension device is tensioned between the braking module and the respective assigned roller. As a result, the braking device according to the invention is in a static or stable state in particular when no loading is occurring. During such periods, the assigned roller is fixedly positioned on the holding device and/or on the guide device. In this case, equilibrium results between the forces which prevail, as transmitted by means of the tension device, between the assigned roller and both the braking module and the state of the tension element in reciprocal action with the rollers.

Applying or releasing the loading device does not change an overall length of the tension element or, depending on the material condition of the tension element, changes the overall length of the tension element only slightly. Applying or releasing the loading device accordingly has a substantial effect on an instantaneous movement, for example an instantaneous position of the assigned rollers within the braking device. The respectively prevailing forces are compensated for by the instantaneous state of the braking modules which likewise influence the movement and the position of the assigned rollers by means of the tension device.

Applying the loading device results in the stress between the at least one braking module and the assigned roller being increased. Releasing the loading device results in a reduction in the stress between the at least one braking module and the assigned roller and therefore to a release of stress. In one possible alternative embodiment, with corresponding design and/or functioning of the braking device and of the at least one braking module, the stress between the at least one braking module and the assigned roller can be increased when the loading device is applied, and reduced when the loading device is released.

The tension element can be embodied in particular as a cable, as a belt or as a chain. It ideally comprises a heavy-duty elastic material, preferably metal, though the tension element can also comprise a plastic which corresponds to the requirements or a material mixture. With suitable material condition, the tension element withstands the forces which occur during operation of the braking device according to the invention, and it is ideally not deformed, or if so, only to a negligible degree, by the forces, so that no appreciable change in length of the tension element is caused. The tension device which is arranged or tensioned between the at least one braking module and the assigned roller can be embodied in a corresponding manner.

A motor vehicle can be equipped with the braking device according to the invention. As a result, loading of braking modules which load vehicle wheels or axles can be advantageously realized through efficient use of available forces.

In one preferred embodiment of the invention, it is provided that the at least one braking module is embodied as a parking brake. The parking brake can thus be adapted to almost any desired vehicle depending on the layout of the block and tackle with a corresponding arrangement of the rollers of the braking device according to the invention and guidance of the tension element along the rollers.

The force transmission device according to the invention for a vehicle for actuating at least one braking module is designed like a block and tackle. In this case, the block and tackle has at least two rollers and a tension element. The at least one braking module interacts with an assigned roller. It is provided that the tension element is anchored at one end and is guided at least over the one assigned roller and at least one additional roller and is connected at another end to a loading device. In the braking device, loading the tension element changes the state of the at least one braking module by moving the assigned roller. This force transmission device functions, in a similar manner to the secondary transmission of the braking device according to the invention, like a block and tackle and is embodied correspondingly. These force transmission devices can be made use of in braking systems of various mechanical and/or electrical as well as hydraulic types in different vehicles.

Further advantages and embodiments of the invention are disclosed in the description and the appended drawing.

It is understood that the abovementioned features and the following features still to be mentioned can be used not only in the respectively specified combinations but also in other combinations or individually without departing from the scope of the invention.

### BRIEF DESCRIPTION OF THE DRAWINGS

The invention is schematically illustrated in the drawing on the basis of an exemplary embodiment and is described in detail in the following with reference to the drawing.

FIG. 1 shows a secondary transmission according to the invention.

FIG. 2 shows a further embodiment of the secondary transmission according to the invention.

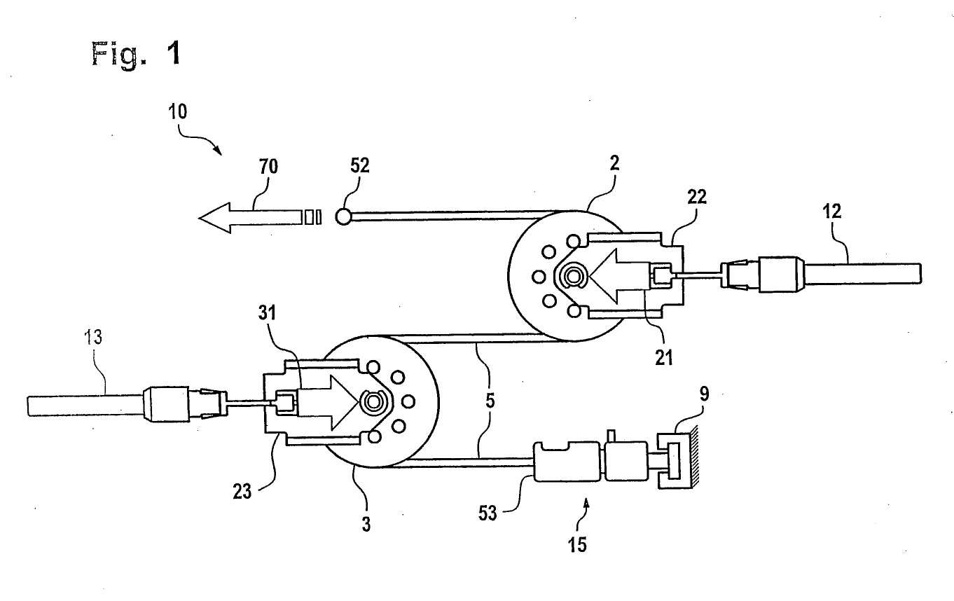

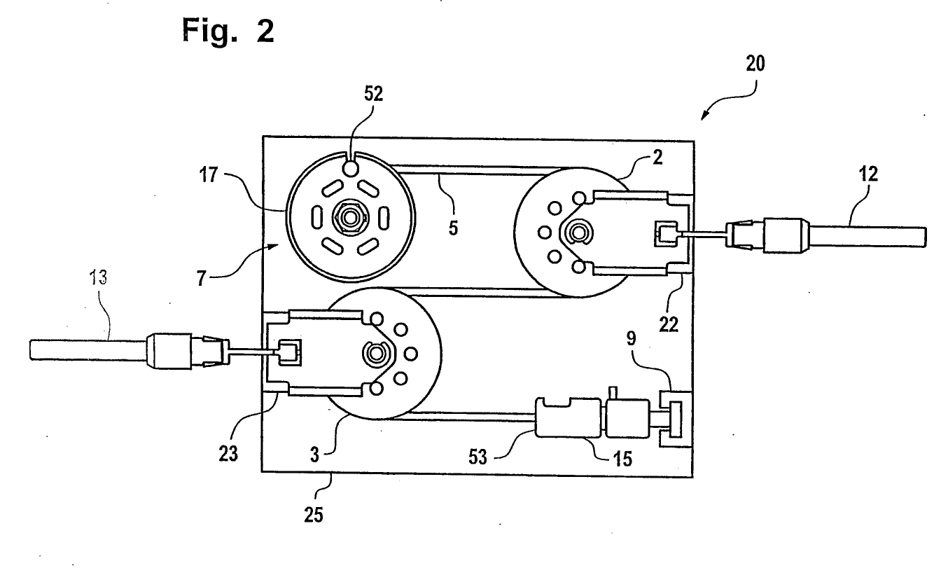

FIG. 1 and FIG. 2 are described in an interrelated and comprehensive manner. Identical reference symbols denote identical components.

### DETAILED DESCRIPTION OF THE INVENTION

The secondary transmission according to the invention which is embodied as a block and tackle has a force transmission device 10 with a tension element 5 or winding element with a first end 52 and a second end 53. The tension element 5 is guided along a roller 2 (right) and a roller 3 (left). A direction of the tension element 5 is in this embodiment changed by the rollers 2, 3 in each case through 180°.

The second end 53 of the tension element 5 is connected in a stationary manner to an anchor 9. In this case, sensors 15 for recording force can be arranged between the second end 53 of the tension element 5 and the anchor 9. A rotational axle of the roller 2 is connected to a tension device 12 by means of a holding and/or guide device 22. This tension device 12 is connected to a braking module which is not illustrated in FIG. 1. A rotational axle of the roller 3 is connected to a tension device 13 by means of a holding and/or guide device 23. This tension device 13 is connected to a braking module which is not illustrated in FIG. 1.

The first end 52 of the tension element 5 is connected to a loading device which is not illustrated in FIG. 1. The entire force transmission device 10 is accordingly designed like a block and tackle.

If the tension element 5 is loaded, it is provided that the first end 52 of the tension element 5 is pulled in the direction of a vector arrow 70. Since a length of the tension element 5 is not changed or is otherwise only changed a negligible amount and the second end 53 of the tension element 5 is anchored on the anchor 9, loading causes a change in position of the two rollers 2, 3. This has the result that the right roller 2 pulls the brake cable 12, as a result of which the braking module which is fastened to the latter is loaded. The left roller 3 likewise pulls the other braking module, which is not illustrated in FIG. 1, by means of the tension cable 13. Loading, in particular pulling the first end 52 of the tension element 5 in the direction of the vector arrow 70, causes the right roller 2 to move in the direction of an arrow 21 to the left and the left roller 3 to move in the direction of an arrow 31 to the right.

In this configuration of the secondary transmission according to the invention, in accordance with the principles of the block and tackle, both the right roller 2 and the left roller 3 are loaded in the direction of the arrows 21 and 31 on the rollers 2, 3 in each case with a force 2*F₀ if the first end 52 of the tension element 5 is loaded in the direction of the vector arrow 70 with a force F₀. The braking modules are correspondingly loaded with forces by means of the tension devices 12, 13.

Depending on the configuration of the braking modules, one axle or one wheel of a vehicle can be loaded with a braking force by the configuration described on the basis of FIG. 1 with the plotted arrows 21, 31 for the forces. This can mean that the braking force at the axle or at the wheel is increased or decreased. Pulling the first end 52 of the tension element 5, as indicated by the vector arrow 70, leads to an increase in braking force. Releasing the loading device, which involves a release of tension of the tension element 5 and a movement of the first end 52 of the tension element 5 in the opposite direction to the vector arrow 70, leads to a decrease in the braking forces which are transmitted to a wheel or axle by means of the braking module.

FIG. 2 shows a secondary transmission for a braking device according to the invention having an alternatively configured force transmission device 20 with comparable components to the force transmission device 10 from FIG. 1. The force transmission device 20 is arranged in a housing 25. The anchor 9 for the second end 53 of the tension element 5 is connected in a stationary manner to the housing 25. The rollers 2, 3 can be positioned relative to the other components by means of guide devices 22.

The first end 52 of the tension element 5 is fastened to a rotating roller 17 on a loading device 7 which can be electromotively operated. Rotation of the rotating roller 17 causes a movement, and in particular a change in position relative to the housing 25, both at the right roller 2 and at the left roller 3. If the rotating roller 17 rotates counterclockwise, as in FIG. 1, the result is that the right roller 2 moves to the left and the left roller 3 moves to the right. An associated pull of the respective tension elements 12, 13 loads the braking modules which are arranged on the tension elements 12, 13 and are not illustrated in FIG. 2. If the rotating roller 17 rotates clockwise, the right roller 2 moves to the right and the left roller 3 moves to the left, resulting in a release of tension.

The force transmission devices 10, 20 function according to the block and tackle principle. The result of this is that the two braking modules, one connected to the right roller 2 by means of a tension device 12 and the other connected to the left roller 3 with the other tension device 13, are loaded in equal measure and/or uniformly and/or simultaneously with equal forces. Furthermore, a force which is introduced as a rotational or linear movement by means of a loading device 7 which is embodied as an electric actuator is passed on to the braking modules in an amplified manner by means of the tension element 5 and the rollers 2, 3.

1-15. (canceled)

16. A braking device for a vehicle in which, to actuate at least one braking module, a secondary transmission which is embodied as a block and tackle is provided to transmit a force between a primary transmission and the at least one braking module, wherein the block and tackle (10, 20) is arranged in a housing (25) and has a tension element (5), one end (52) of the tension element (5) being fastened to a rotating roller (17), which is arranged in the housing (25), on a loading device (7) which can be electromotively operated.

17. The braking device as claimed in claim 16, in which the primary transmission is embodied as a worm gear.

18. The braking device as claimed in claim 16, which is embodied as an electric motor with the primary transmission and the secondary transmission.

19. The braking device as claimed in claim 16, in which the block and tackle (10, 20) has the tension element (5) and at least two rollers (2, 3), which interact, and the at least one braking module interacts with an assigned roller (2, 3), the tension element (5) being anchored at one end (53) and being guided at least over the one assigned roller (2, 3) and at least one additional roller (3, 2) and being connected at the other end (52) to the electromotive loading device (7) by means of the rotating roller (17), in which device loading the tension element (5) changes the state of the at least one braking module by moving the assigned roller (2, 3).

20. The braking device as claimed in claim 16, in which each roller (2, 3) changes a direction of the tension element which is tensioned between the loading device (7) and an anchor (9).

21. The braking device as claimed in claim 16, in which, on account of loading, the tension element (5) causes a change in position of the at least one assigned roller (2, 3).

22. The braking device as claimed in claim 16, in which the at least one braking module is connected to the respective assigned roller (2, 3).

23. The braking device as claimed in claim 16, in which a tension device (12, 13) is arranged between the at least one braking module and the respective assigned roller (2, 3).

24. The braking device as claimed in claim 16, in which a stress between the at least one braking module and the respective assigned roller (2, 3) can be changed.

25. The braking device as claimed in claim 16, in which the at least one assigned roller (2, 3) is arranged on a holding device (22, 23, 25) in a moveable manner.

26. The braking device as claimed in claim 16, in which the tension element (5) is embodied as a cable.

27. The braking device as claimed in claim 16, in which the at least one braking module is designed to load a wheel and/or an axle of the motor vehicle.

28. The braking device as claimed in claim 16, in which the at least one braking module is embodied as a parking brake.

29. A force transmission device for a vehicle for actuating at least one braking module, which is embodied as a block and tackle, wherein the block and tackle (10, 20) is arranged in a housing (25) and has a tension element (5), one end (52) of the tension element (5) being fastened to a rotating roller (17), which is arranged in the housing (25), on a loading device (7) which can be electromotively operated.

30. The force transmission device as claimed in claim 29, in which the block and tackle has the tension element (5) and at least two rollers (2, 3), which interact, and the at least one braking module interacts with an assigned roller (2, 3), a tension element (5) being anchored at one end (53) and being guided at least over the one assigned roller (2, 3) and at least one additional roller (3, 2) and being connected at the other end (52) to the loading device (7) by means of the rotating roller (17), in the case of which device loading the tension element (5) changes the state of the at least one braking module by moving the assigned roller (2, 3).
